(19) United States
(12) Patent Application Publication
(10) Pub. No.: US 2004/0255119 A1
(43) Pub. Date: Dec. 16, 2004

(54) Memory device and passcode generator

(76) Inventors: Masaharu Ukeda, Yokohama (JP); Motoyasu Tsunoda, Sagamihara (JP); Kunihiro Katayama, Chigasaki (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/808,390

(22) Filed: Mar. 25, 2004

(30) Foreign Application Priority Data
Mar. 26, 2003 (JP) 2003-084091

(51) Int. Cl. H04L 9/00

(52) U.S. Cl. 713/169; 713/171

(57) ABSTRACT

The memory device of the present invention comprises an interface for receiving time information from a host device; an EEPROM for storing pass-information which is related to the pass-information of a server device and which is defined for each user for the memory device; and a random number generator for generating a passcode ion the basis of the pass-information in the EEPROM and the time information from the host device in response to a request from the host device and sending the passcode to the host device without sending the pass-information to the host device.

The present application claims priority from the Japanese patent application JP2003-084091 filed on Mar. 26, 2003, the content of which is hereby incorporated by reference into this application.

### BACKGROUND OF THE INVENTION

The present invention relates to memory devices (e.g., memory cards) and passcode generators used for allowing one computer to verify the other computer, that is, for verification between a plurality of computers (e.g., a server device and a client terminal device) or used for allowing one computer to verify a user of the other computer. More particularly, the invention relates to a memory device and a passcode generator capable of generating a one-time passcode used for the verification.

A prior art is disclosed in, e.g., Japanese Patent Laid-open No. 2002-259344. In the prior art, a user ID, present time information and common secret information are used to obtain a hash value in a mobile phone or a token, generate one-time password and display it on a display unit. A user PC receives the inputs of the user ID and the one-time password and transmits the user ID and the one-time password a user verification server. The user verification server uses the user ID, the present time information and the common secret information to generate the one-time password likewise and verifies the thus generated one-time password and the one-time password transmitted from the user PC.

### SUMMARY OF THE INVENTION

In the aforesaid prior art, since the secret information used for creation of the one-time passwords is shared by the plurality of users, the secret information is likely to leak. In addition, since the user ID used for generation of the one-time passwords goes out from the mobile phone or the token, the user ID is likely to leak. Consequently, there occurs the possibility that the one-time passwords are created by a third party who stole the secret information and the user ID. Additionally, the aforesaid prior art does not consider verification of the time information within the mobile phone or token generating the one-time password.

It is an object of the present invention to provide a memory device and a passcode generator capable of prevent leakage of pass-information to prevent a third party from generating a illegal passcode.

It is another object of the present invention to provide a memory device and a passcode generator capable of preventing a user or a third party from illegally changing the time information within a card.

According to the present invention, in response to a request from a host device, a passcode is generated on the basis of pass-information in a volatile memory in a memory device and time information from the host device and the pass code is transmitted to the host device without transmitting the pass-information to the host device. Then, the host device uses the passcode to perform mutual verification with the server device. Preferably, the memory device is configured such that a success-time of the mutual verification between the memory device and the server device via the host device cannot be illegally updated and whether or not the memory device can be used is controlled on the basis of the success-time that cannot be updated illegally.

In addition, according to the present invention, when time information is received from a first computer (e.g., a host device), the time information from the first computer is compared with time information stored in a time examination unit or a memory. When the time information from the first computer is later than time information stored in the time examination unit or the memory, the time information stored in the time examination unit or the memory is updated to the time information from the first computer. When the time information from the first computer is later than the time information stored in the time examination unit or the memory, a passcode is generated from the pass-information stored in the memory and the time information stored in the time examination unit or the memory, and then the passcode and a user ID are sent to the first computer. Then, the first computer transmits the passcode to the second computer (e.g., a server device) and the second computer uses the passcode to verify a user.

### BRIEF DESCRIPTION OF THE DRAWINGS

FIG. 1 is a block diagram for showing a system to which the present invention is applied;

FIG. 2(a) and FIG. 2(b) are diagrams for illustrating an internal configuration of a time examination unit;

FIG. 3 is a flowchart for illustrating a basic configuration of the system to which the present invention is applied;

FIG. 4 is a diagram for illustrating an operation model to which the present invention is applied;

FIG. 5 is a flow-chart for showing an expiration managing means in the present invention; and

FIG. 6 is a diagram of a card including a controller and a flash memory.

### DETAILED DESCRIPTION OF THE INVENTION

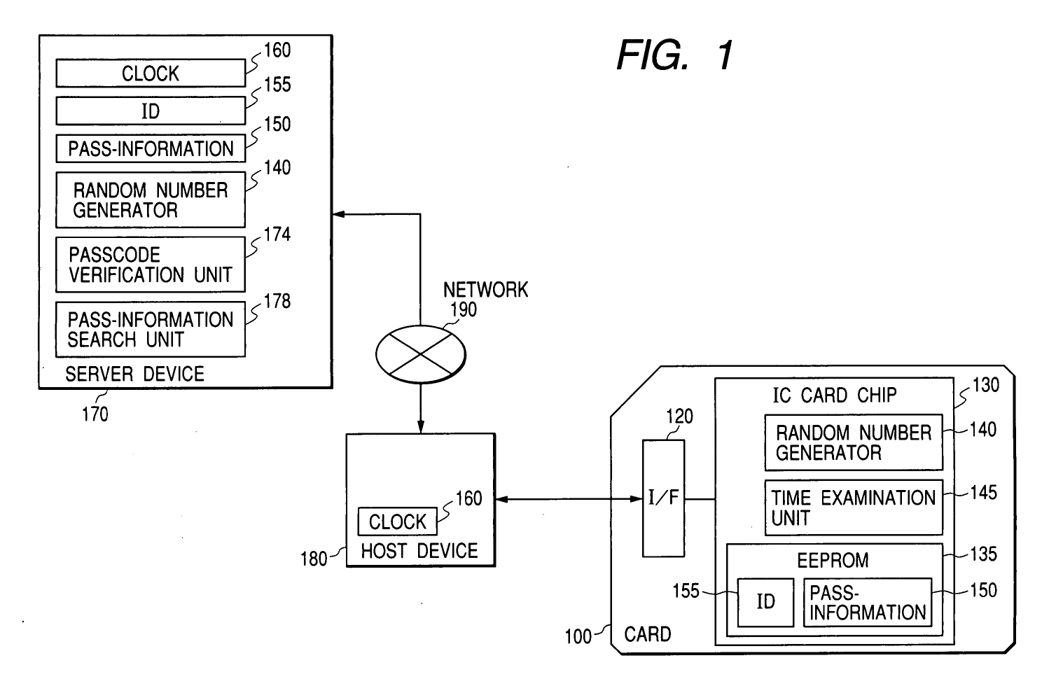

FIG. 1 is a diagram for showing a system to which the present invention is applied.

A card 100 comprises an interface 120 and an IC card chip 130. The card 100 applies to an MMC, a Secure MMC, an SD (Secure Digital) Memory Card, a Memory Stick, a Compact Flash, an IC card or the like. The MMC is an abbreviation of a Multi Media Card, which is a registered trademark of Infineon Technologies AG. The Memory Stick is a registered trademark of Sony Corporation. The Compact Flash is a registered trademark of U.S. San Disk Corporation.

The interface 120 applies to an MMC interface, an SD interface, a Memory Stick interface, an IC card interface, a Compact Flash interface and a wireless interface and the like.

The IC card chip 130 is configured such that a memory (e.g., EEPROM; Electrically Erasable Programmable ROM), a calculation processing device, a logic circuit and wiring connecting these devices are mainly mounted on one-chip. The IC card chip 130 may have a function of detecting the analysis thereof made from the outside by use of a semiconductor analysis apparatus and a function of, upon detection of the analysis, erasing data in a memory and stopping its computation. In addition, the IC card chip 130 has an EEPROM 135 storing ID 155 and pass-information 150 (e.g., a seed value for generating a passcode), a time examination unit 145 and a random number generator 140. The time examination unit 145 and the random number generator 140 each comprise a calculation processing device and a logic circuit.

The ID 155 and the pass-information 150 are individual information required for verification. Specifying the ID 155 enables the pass-information 150 to be identified. In addition, the ID 155 is also used for identifying the user's pass-information 150 at the server device 170. The pass-information 150 in the card 100 agrees with the pass-information in the server device 170.

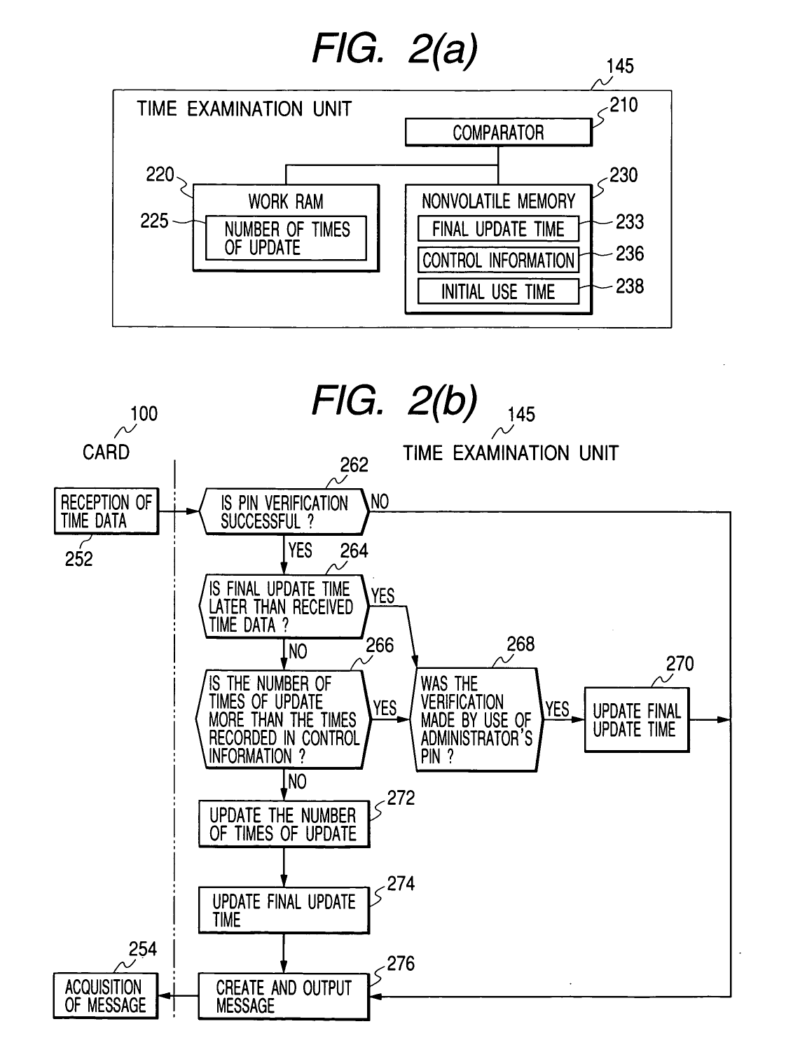

The time examination unit 145 has architecture shown in the block diagram of FIG. 2(a). The time examination unit 145 has a comparator 210, a work RAM (Random Access Memory) 220 and a non-volatile memory 230. In this case, the work RAM 220 has the number of updates stored therein, and the nonvolatile memory 230 stores a final update time 233, control information 236 and initial use time 238. However, the final update time 233, control information 236 and initial use time 238 may be stored in the EEPROM 135. The comparator 210 is a device for verifying the time data inputted from an external unit.

The flowchart of FIG. 2(b) illustrates architecture implemented when the time data is verified. Upon receipt of the time data (step 252), the time examination unit 145 verifies PIN (Personal Identification Number) (step 262). This processing operation may be carried out when either the card 100 or the random number generator 140 is limited in use or may be omitted when either a user or a using device is not limited. The verification of PIN is architecture in which a correlation between the PIN inputted from the host device 180 and the verification data held in the card 100 is checked and a user is authorized when the checked correlation satisfies a certain reference. When the PIN verification is successful, either the user or the host device can get either a data access right or a function utilizing right. For example, when a user uses either a stored character string or numerical string as the PIN, it becomes possible to perform user authentification. When the data including the character and numerical strings memorized by the user and information specific to the host device 180 is scrambled through random numbers and is used as input data, the host device 180 can be limited in use. Here, the information specific to the host device corresponds to a serial number of the host unit, an IP address or the like.

When both the verifications of the time data and PIN are unsuccessful, an error message is created (step 276) and returned back to the host device. When both verifications are successful, the inputted time data is compared with the final update time 233 (step 264). The final update time 233 is a time in which the time data in the card 100 is lately updated. However, the nonvolatile memory 230 may store the inputted time data in sequence. In the usual operation, it is assumed that it is impossible to use the time not later than the time once inputted. Such architecture as above makes it possible to use access limitation combined with the expiration of data described later. In addition, this architecture has a role of preventing such an action that an illegal user operates the clock of the host device 180 to get a future time, and return the time to the original time, thereby steeling a password while an authorized user is not aware of that. Further, the host device 180 may read out the final update time 233 in order to prevent a theft of the passcode.

When the final update time 233 is later than the time data, it is checked whether or not the verification is carried out with administrator PIN (step 268). The final update time 233 may advance remarkably relative to the present time due to erroneous handling or an erroneous operation of the clock in the host device. In this case, such a recovery means is applicable that a system administrator inputs the administrator PIN and the correct time to turn the final update time 233 back to the correct time. In place of the system administrator, a user may also operate the foregoing.

When the time data is later than the final update time 233, it is judged whether or not the number of times of update 225 exceeds the number described in the control information 236 (step 266). The number of times of update 225 is defined as the number of updates of the final update time 233 during a certain period of time. This update number corresponds to the number of updates after a power supply is turned ON, the number of updates under a certain PIN, the number of updates during a certain period of time on the basis of the final update time 233, or the like. In addition, the number of times of update 225 may be prepared for each of these requirements. The number of times of update 225 may be reset at a timing corresponding to the classification in response to a request from the host device 180. The number of times of update 225 may also be stored in the nonvolatile memory 230 in order to continue a counting operation even after the power supply is turned OFF. A procedure 266 may be used merely for access limitation using the control information 233 and final update time 236. Access limitation may be provided, for example, in which access may be possible thousand times in two years from initial use time 238. The initial use time 238 is defined as a date in which the time update is initially performed. In addition, in place of storing the number of times of update 225, the changed final update time 233 is stored as a log. In this case, it may also be determined how many logs in the past are held in accordance with the requirement represented by memory capacity and the control information 236. Even if the number of times of update 225 exceeds the number of times described in the control information 236, the final update time 233 may be updated if the verification is performed with the administrator PIN.

When the number of times of update 225 does not reach the number of times described in the control information 236, the number of times of update 225 is updated (step 272), the final update date 233 is updated (step 274) and a message is set and outputted (step 276). The card 100 reads this information to determine the next operation (step 254).

The random number generator 140 in FIG. 1 is a calculator for generating unforecatable output data. However, the random number generated by the random number generator 140 is such that the output data calculated with respect to a certain input data is unique. The random generator 140 corresponds to a calculator using a hush function such as SHA-1 or MD5 or a device using a specific scramble function. In the present invention, the random number generated by the random number generator 140 is utilized as a passcode 310.

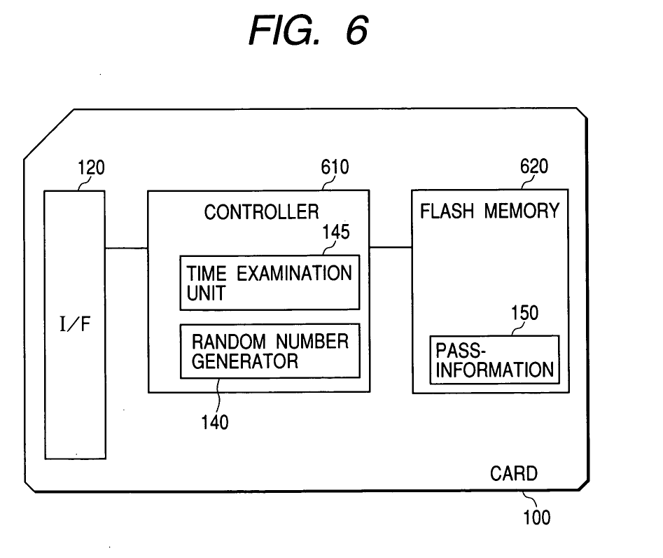

However, as shown in FIG. 6., the card may be a system comprising a controller 610 and a flash memory 620. In this case, the pass-information 150 and ID 155, which are encrypted, may be stored in a flash memory 620, and a controller 610 may include the time examination unit 145 and the random number generator 140. The card may include the IC card chip 130 in addition to the controller 610 and the flash memory 620. In this case, the IC card chip 130 may store the ID 155 and pass-information 150, and include the time examination unit 145 and random number generator 140. Alternatively, the IC card chip 130 may store only the ID 155 and pass-information 150 therein and the controller 610 may include the remaining functions. With this configuration, the pass-information can be stored in an IC card chip with a high degree of safety. In addition, provision of a CPU having higher performance than the IC card chip 130 or a dedicated hardware allows the controller 610 capable of high-speed processing to perform processing such as generation of random numbers. Thus, there is produced an effect of enhancing the entire processing efficiency. The time examination unit 145 and the random number generator 140 used in this case may each be software executed in the card, or otherwise, may each be mounted as hardware.

The ID 155 and pass-information 150 stored in the IC card chip 130 are rewritable data, and they are stored in the EEPROM 135, i.e., a nonvolatile memory that can be erased and written in an electronic manner or physical property manner.

The card 100 is connected to the host device 180 through an interface 120. The host device 180 is an individual use terminal device. The host device 180 corresponds to a PC (abbreviation of a Personal Computer), a PDA (Personal Digital Assistant), a mobile phone, Kiosk terminal or a gate device permitting access to a room or place. The host device 180 has the clock 160 or an interface for receiving time data sent from a server device 170. The host device 180 sends time date to the card 100 to calculate the passcode. In this case, a password for use authentification may be inputted to limit the use of the card 100.

In addition, it is assumed that the host device has an interface that can be connected to a network such as the Internet, LAN or the like and further the host device can be connected to the server device 170. The server device 170 may have a function of performing authentification incorporated therein, or otherwise, an authentification server may be provided.

The server device has the clock 160, sets of ID 155 and pass-information 150, whose number is equal to the number of users, a random number generator 140, a passcode verification unit 174 and a pass-information search unit 178.

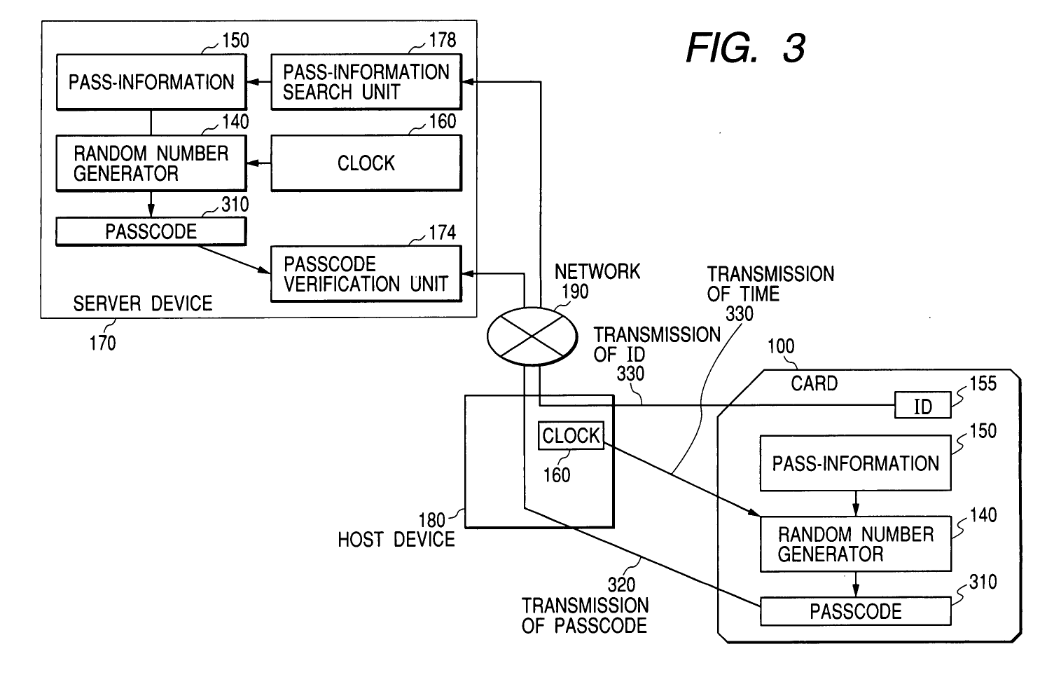

FIG. 3 shows architecture of authentification utilizing this system. The host device 180 instructs the card 100 to generate the passcode 310 and concurrently inputs time information got from the clock 160 to the card 100. The card 100 generates the passcode 310 by inputting the inputted time and pass-information 150 to the random number generator 140. The card 100 transmits the generated passcode 310 and the ID 155 to the host device 180. The host device 180 transmits the passcode 310 and ID 155 received from the card 100 to the server device 170 through the network 190. The server device 170 specifies the pass-information 170 from the data received from the host device 180 through the pass-information search unit 178 by use of the ID 155. Then, the passcode 310 is generated by inputting the specified pass-information 150 and time information got from the clock 160 are inputted to the random number generator 140. Availability or non-availability is judged by verifying the obtained passcode 310 and a passcode transmitted from the host device 180 with the passcode verification unit 174.

In this case, the data inputted into the card 100 through this host device may include the PIN employed to use the card 100 and the time information. In this case, the card 100 performs password verification before generation of the passcode. A plurality of passwords used for performing verification can be used in accordance with service to be used or authorization. In addition, if the card 100 can be utilized in a plurality of systems or one system can have a plurality of sets of IDs and the passcodes 310, provision of IDs and ID identifiers as input data allows the pass-information 150 used for generating the passcode 310 to be selected. In addition, different pieces of pass-information 150 may be used in the order of issuing. Further, if it is necessary to input PIN also for the operation of the host device 180, the PIN used for the operation of the host device 180 may be the PIN to be inputted to the card 100.

Before the random number generator 140 is used, the time examination unit 145 may be used to verify the inputted time. In addition, if an expiration date is set in the pass-information 150, this expiration date is judged whether or not the pass-information may be used after the verification has been carried out. If the pass-information 150 exceeds the expiration date, not only the use of the pass-information may be limited but also the pass-information may be deleted. In addition, unless the server device 170 carries out the authentification using all the generated passcodes, data outputted from the card 100 is limited to the number of bytes used by the server device 170, thereby making the analysis of pass-information 150 difficult. It is preferred that the number of bytes may be changed by using the administrator PIN. In addition, when the passcode is transmitted from the host device 180 to the server device 170, the character and numerical strings memorized by the user and data identifying the host device 180 may be sent together with the passcode. In this case, after identifying the user's pass-information 150 by use of the ID 155, the server device 170 may verify the character string accompanied with the passcode by use of a reference PIN associated with the pass-information 150. In addition, this operation can be carried out at a timing in which the passcode is verified by the passcode verification unit 174. A time lag may probably occur between a time for generation of the random number in the server device 170 and that in the host device 180. Therefore, data transmitted in advance from the server device 170 to the host device 180 through the network 190 may be used as the time information transmitted to the card 100. Additionally, the time information inputted to the random number generators 140 may easily be synchronized by discarding a digit of second or the server device 170 may calculate a passcode before several minutes or after several minutes, thus coping with the time lag.

This system allows the card 100 to manage the pass-information 150 and generate the passcode. Therefore, the system has an effect that safety of the pass-information can be more increased than that when the pass-information is read out to the host device 180. In other words, it is possible to prevent the pass-information 150 from being stolen. Further, a host application using the card 100 can be used irrespective of any algorisms of the random number generator 140, so that this host application may have effects of enhancing confidentiality of the random number generator 140 and simplification of the host application. In addition, storing the initial use time 238 produces an effect of reducing manufacturing cost because it is not necessary to set the expiration date corresponding to the present time for each card. Further, only enabling a new time to be always registered with the final update time 233 configures service described in the following preferred embodiment.

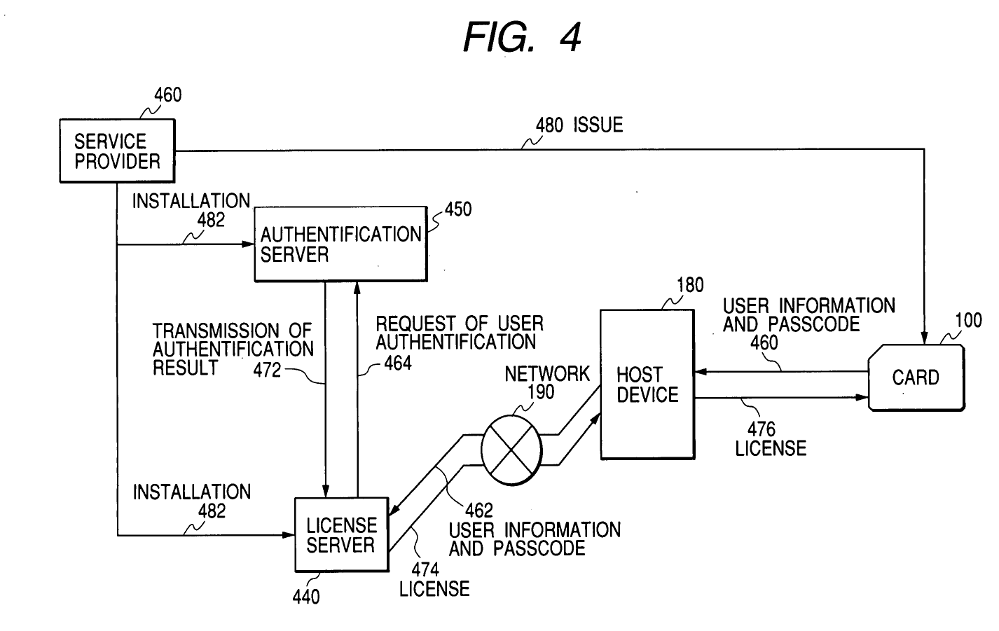

FIG. 4 shows the preferred embodiment of the service utilizing this system. A service provider 460 issues the card 100 having a set of pass-information 150 and ID 155 to a user (at 480). In addition to a random number generating function 145, the card 100 has a function of protecting a copy right by encrypting a communication path of data. An encrypting method for the communication path at this time may be configured such that the service provider and the user have pairs of a certificate and a secret key, the pairs are used to generate session keys, and the session keys are encrypted for exchange or such that the service provider and the user have a set of common keys in advance, an optional common key is utilized to generate session keys and exchange them therebetween. The use of this function of protecting a copyright makes it possible to distribute contents while the license for using the contents is prevented from being copied and stolen. The service provider 460 prepares a license server 440 and an authentification server 450 to provide service (at 482). The license server 440 is connected to the host device 180 through a network 190 and further connected to the authentification server 450 through the network 190, LAN or the like. In this case, this system is constructed such that the host device 180 is directly accessed to the authentification server 450 or is connected to the authentification server 450 or the license server 440 via a router. It is assumed that the host device 180 can use the card 100 the service provider issues (at 460). The preferred embodiment will be described by way of example of news distribution service. Provided that the pass-information 150 for use in receiving the news distribution service for one month in advance is stored in the card 100, and the license server distributes separately encrypted contents and the license information used for utilizing the contents. Further, it is assumed that expiration date information is given to each of the pass-information and the license and in the service selected by a user a browsing period for each piece of news is within one week.

When this service is to be used, a user uses the card 100 to generate the passcode on the basis of the time received from the host device 180 and sends it to the host device 180 together with user information including the ID 155 (at 460). The host device 180 sends the passcode and the user information received from the card 100 to the license server 440 through the network 190 (at 462). The license server 440 transmits the sent passcode and ID 155 to the authentification server 450 to perform user authentification (at 464). When the user authentification is successful, the authentification server 450 sends back the result of authentification to the license server 440 (at 472). Upon confirming that the authentification is successful, the license server 440 transmits the encrypted contents and the license for use in utilizing the contents to the host device 180 (at 474). The license can decrypt the encrypted contents. The encrypted contents may also be transmitted by a server other than the license server 440 that has issued the license. In this case, the license is stored directly in the card 100 because it is protected by encryption communication. However, the license may be stored in the RAM in the host device 180 or the flash memory 620 in the card 100 as usages because its placing location is optional as long as the license is protected.

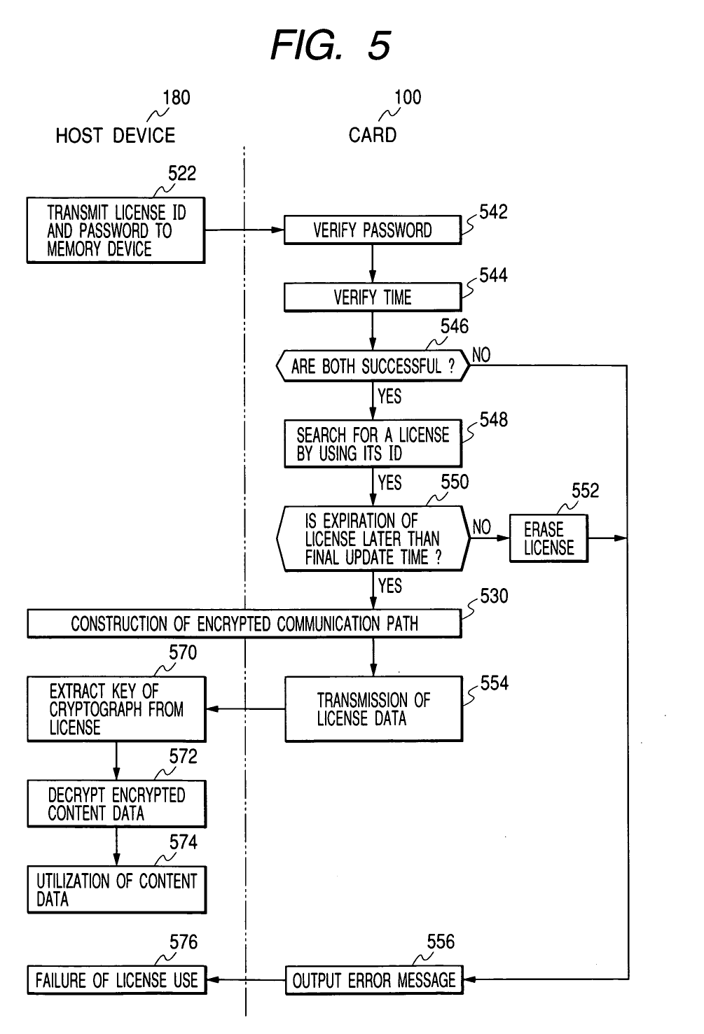

FIG. 5 shows a procedure for reading out a license stored by use of the system shown in FIG. 4 and browsing contents. If needed, the host device 180 promotes a user to input a password and sends it to the card 100 together with a license ID intended to use (step 522). The card 100 verifies the sent password (step 542) and then verifies the time by use of the time examination unit 145 (step 544). Then, if both the verifications are successful, the license specified by the license ID is searched (step 548). However, if either the password or the time is unsuccessful in the verification, an error message is created (step 556) and returned to the host device 180 (step 576). In this case, the time maybe verified after the password has been successful in the verification. An object of verifying the time after the verification of the password is to prevent the final update time 233 from being rewritten by an illegal user. In addition, the license ID may not be inputted at the same time of inputting the password. If the storing position of the license is fixed, the license ID may not be inputted.

If the license is found, the expiration date of the license is confirmed whether it is later than the final update time 233 or not (step 550). If the final update time 233 is later than the expiration date of the license-, the license may be deleted since the license cannot be used (step 552). Alternatively, the license may be made invalid by use of a flag. The license may likely be invalid due to the fact that the final update time 233 is set to a date later than an actual date caused by inputting the erroneous time. In this case, if a means for invalidating the license with the flag is adopted, the license can be recovered by making the flag valid. For a countermeasure against the case where the license could not be utilized due to erroneous inputting or error in communication, it is desirable that the license hold the license ID by which the license server can identify each license and the communication ID by which the license server can identify the communication session. If such information are kept held even after the license has been deleted, the license can be recovered in the event that it is deleted due to the erroneous operation.

When the expiration date of the license is later than the final update time 233, an encrypted communication path is constructed between the card and the application or library of the host device 180 (step 530). Thereafter, the card 100 transmits the license to the host device 180 through the encrypted communication path. The host device 180 can extract the key of cryptograph for decrypting the encrypted contents from the license (step 570), and decrypt the encrypted content data (step 572) for usage (step 574).

According to the model shown in FIG. 4, the encrypted contents correspond to news data. Using this architecture, a user performs authentification with the present time when the user gets everyday-news from the license server, so that the latest update time 233 in the card is updated to a correct time at this timing. Accordingly, as long as the user desires the distribution of everyday-news, the time in the card continues to be updated to the correct time. Consequently, the license whose expiration date has passed before one week cannot be used automatically. Service to which such a system can be applied corresponds to a rental-based distribution of music, video-contents, software or the like. The prior art system could not be used in this way because the authentification for the service and the expiration date of the contents were managed independently. In addition, since the expiration date of the license can be judged in the card, the illegal use of the license can be prevented more securely than the case where the expiration date of the license is managed by only the software of the host device 180.

The card shown in FIG. 4 has a function of protecting a copy right and this function enables to prevent copying of the license or tapping. However, this function may be applied to another architecture such that both the pass-information 150 and ID 155 are downloaded from the license server for usage. In this case, since the pass-information 150 is data that should not be read out by the host device 180, it is desirable that information for limiting access be added to each pieces of data to be stored in the card 100, or the data be stored in the card 100 in an area prohibiting the reading-out from the host device 180.

In addition, the authentification system shown in FIG. 3 may have such an architecture that the present time used by the host device 180 for calculation is transmitted to the server device 170 in addition to the passcode generated by the random number generator and the ID. If this architecture is used, the server device 170 can eliminate a necessity to calculate the time lag between the server device 170 and the host device 180, so that the number of times of communication can be reduced to the number smaller than a case of receiving a time from the server device 170 for calculating the time lag, thereby reducing a processing load. Additionally, if the time quite different from the present time held by the server is sent, no verification may be carried out.

The passcode is generated within the card on the basis of time given from the outside and the pass-information stored in the card, so that the pass-information is not sent out of the card, whereby the concealability of the pass-information can be enhanced. In this case, the time examination unit verifies the time given from the outside so as to prevent the inputted irregular time from being used.

In accordance with the present invention, the pass-information for use in generating the passcode is not transmitted out of the card, so that it is possible to prevent leakage of the pass-information, which prevents a third party from generating the passcode illegally.

In accordance with the present invention, the pass-information is defined for each user, so that the leakage of pass-information can be prevented, which prevents a third party from generating the passcode illegally.

In accordance with the present invention, the time information stored in the card is updated by use of the time information that was successful in authentification, so that it is possible to prevent the user or a third party from irregularly updating the time information stored in the card. It is possible to prevent a user or a third party from using a card or data whose expiration date has been passed by changing irregularly the time information since for example the information that was used to generate the passcode is used to confirm whether or not the expiation date has passed.

What is claimed is:

1. An individually usable memory device, connectable to a host device, for performing mutual authentification between a server device and the memory device by use of a passcode, comprising:
an interface adapted to receive time information from said host device;
a non-volatile memory for storing pass-information which is related to pass-information of said server device and which is defined for each user; and
a processing device which, in response to a request from said host device, generates said passcode from the pass-information in said non-volatile memory and a time information from said host device, and which transmits said passcode to said host device through said interface without sending said pass-information to said host device.

2. The memory device according to claim 1, wherein the memory device is configured such that a success-time of the mutual authentification between said memory device and said server device via said host device is stored in said non-volatile memory, so that it is impossible to illegally alter the stored success-time afterwards, and whether or not the memory device may be used is controlled on the basis of said success-time that cannot be illegally altered.

3. The memory device according to claim 2, wherein:
said processing device includes a time examination unit for verifying the time information from said host device;
said time examination unit stores the time information when an initial time verification is successful; and
said processing device causes generation of said passcode to be failed when the time information from said host device is not later than the success time of said connection authentification, and causes generation of said passcode to be failed or said passcode to be deleted when the time information from said host device is later than an expiration date of said pass-information, so that the passcode to be transmitted to said host device may be limited to the predetermined number of bytes.

4. The memory device according to claim 2, wherein
said processing device encrypts license data that can be used for protection of a copy right after the mutual authentification with either said host device or said server device, stores the license date in said non-volatile memory, stores said pass-information in said non-volatile memory as license data, and with reading-out of the license data being prohibited afterwards, makes it possible to use the license data for the generation of said passcode.

5. The memory device according to claim 2, wherein:
said non-volatile memory holds license data with an expiration date; and
said processing device compares the expiration date of said license data with said success-time when said license data is accessed, and stops the access to the license data with said expiration date or delete said license data when the expiration date is not later than said success time.

6. A single chip microcomputer that is mounted on an individually usable memory device, connectable to a host device, for performing mutual authentification between a server device and the memory device by use of a passcode, comprising:
receiving means adapted for receiving a time information from said host device;
reading-out means for reading out from a non-volatile memory in said memory device a pass-information which is related to a pass-information of said server device and which is defined for each user for said memory device;
generating means for generating said passcode on the basis of said pass-information and time information from said host device; and
transmittance means for transmitting said passcode to said host device through an interface within said memory device without transmitting said pass-information to said host device.

7. The single chip microcomputer according to claim 6, wherein a success-time of the mutual authentification between said memory device and said server device via said host device is written into said non-volatile memory, said memory device is configured such that said success-time stored cannot be illegally altered afterwards, and whether or not the memory device can be used is controlled on the basis of said success-time that cannot be illegally altered.

8. A passcode generator, connectable to a first computer used by a user, which generates a passcode for authenticating the user with a second computer capable of communicating with said first computer, comprising:
an interface connected to said first computer;
a memory for storing pass-information agreeing with pass-information stored in said second computer and a user ID of said user;
a time examination unit for, time information being stored therein or in said memory, comparing time information from said first computer with the time information stored therein or in said memory when receiving the time information from said first computer, and updating the time information stored therein or in said memory to the time information from said first computer when the time information from said first computer is later than the time information stored therein or in said memory; and
a random number generator for generating said passcode on the basis of the pass-information in said memory and the time information stored therein or in said memory, and sending said passcode and said user ID to said first computer through said interface when the time information from said first computer is later than the time information stored therein or in said memory.

9. The passcode generator according to claim 8, wherein said random number generator sends error information in place of said passcode to said first computer through said interface when the time information from said first computer is not later than the time information stored therein or in said memory.

10. The passcode generator according to claim 8, wherein
said memory stores a password; and
said time examination unit, when the time information from said first computer is not later than the time information stored therein or in said memory, compares the password from said first computer with the password in said memory, and if the password from said first computer agrees with the password in said memory, updates the time information stored therein or in said memory to the time information from said first computer.

11. The passcode generator according to claim 8, wherein
said memory stores data with an expiration date therein; and
said passcode generator includes a data supervising unit for verifying said expiration date using the time information stored therein or in said memory which were updated, when the time information from said first computer is later than the time information in said memory.

12. The passcode generator according to claim 11, wherein,
said memory stores encrypted content data therein;
said data with an expiration date is a license for decrypting said content data; and
said data supervising unit receives said data with an expiration date sent from said second computer through said first computer and said interface when said second computer is successful in user authentification using said passcode and stores said received data with an expiration date.

13. The passcode generator according to claim 11, wherein
said memory stores a password therein;
said data supervising unit makes said data with an expiration date invalid when the time information from said first computer is not later than the time information stored therein or in said memory, and makes said invalidated data with an expiration date valid when the password from said first computer is compared with the password in said memory and the password from said first computer agrees with the password in said memory.

14. The passcode generator according to claim 13, wherein said password is a password given to a administrator different from said user.

15. The passcode generator according to claim 8, wherein,
said time examination unit stores the number of updates of time information stored therein or in said memory and sends error information in place of said passcode to said first computer through said interface when said number of updates exceeds a predetermined number of update times within a predetermined period of time.

16. A passcode generator, connectable to a first computer used by a user, which generates a passcode for authenticating the user with a second computer capable of communicating with said first computer, comprising:
an interface connected to said first computer;
a memory for storing pass-information agreeing with the pass-information stored in said second computer and a user ID of said user;
a time examination unit for, time information stored therein or in said memory, sending the time information stored therein or in said memory to said first computer, receiving the time information in said first computer from said first computer when said first computer judges that the time information in said first computer is later than the time information stored therein or in said memory, and updating the time information stored therein or in said memory to the time information from said first computer; and
a random number generator for generating said passcode on the basis of the pass-information in said memory and said time information and sending said passcode and said user ID to said first computer through said interface when the time information in said first computer is later than the time information stored therein or in said memory.
